(19) United States
(12) Patent Application Publication
(10) Pub. No.: US 2011/0189907 A1
(43) Pub. Date: Aug. 4, 2011

(54) AMPHIBIAN

(75) Inventor: Alan Timothy Gibbs, London (GB)

(73) Assignee: GIBBS TECHNOLOGIES LTD, Warwickshire (GB)

(21) Appl. No.: 12/674,892

(22) PCT Filed: Aug. 22, 2008
(86) PCT No.: PCT/GB08/02856

§ 371 Date: Apr. 15, 2011

(30) Foreign Application Priority Data
Aug. 24, 2007 (GB) GB 0716581.4

(51) Int. Cl. B60F 3/00

(52) U.S. Cl. 440/12.52

(57) ABSTRACT

Planing amphibian (10) comprises hull (12) and a pair of wheels (20) mounted on a retractable suspension assembly (22). At least one land drive and at least one separate marine drive (40) are provided. A wheel retraction mechanism is provided for moving the wheels between a deployed wheel position for use of the amphibian on land (FIGS. 2 and 4) and a retracted wheel position above a waterline of the amphibian for planing on water. The suspension assembly comprises suspension arms (24) outside the pair of wheels (20) so that the wheels (20) lie between the arms (24). Marine drives (40) may be inboard of the wheels (FIG. 2) or outboard thereof (FIG. 4). An axle (28) with a differential (29) may be provided (FIG. 3). Suspension and retraction may be provided by means of torsion bars (30) with a cranked central section (54, 55, FIG. 3).

The present invention relates to an amphibian, and in particular, to an amphibian with retractable wheels.

A number of suspension layouts for amphibians have been proposed. Such suspension layouts allow sprung and damped movement of the wheels when the amphibian is on land, and retraction of the wheels for use of the vehicle on water. The suspension is generally inboard of the wheel, for example as known from US 2005/0034646 to Royle. This has the disadvantage that the width of the hull between the wheels is restricted for a given width of the amphibian, as at least a lower suspension arm must project through the plane of the hull to support the wheel in protracted land mode. Space must also be allowed for suspension rebound travel. An example of this restriction may be seen from the Applicant's co-pending application published as US 2007/0,006,788 A1.

The present invention provides an amphibian according to claim 1. Thus, the width of the hull is not restricted by the suspension.

Embodiments of the present invention will now be described, by way of example only, with reference to the accompanying drawings in which:

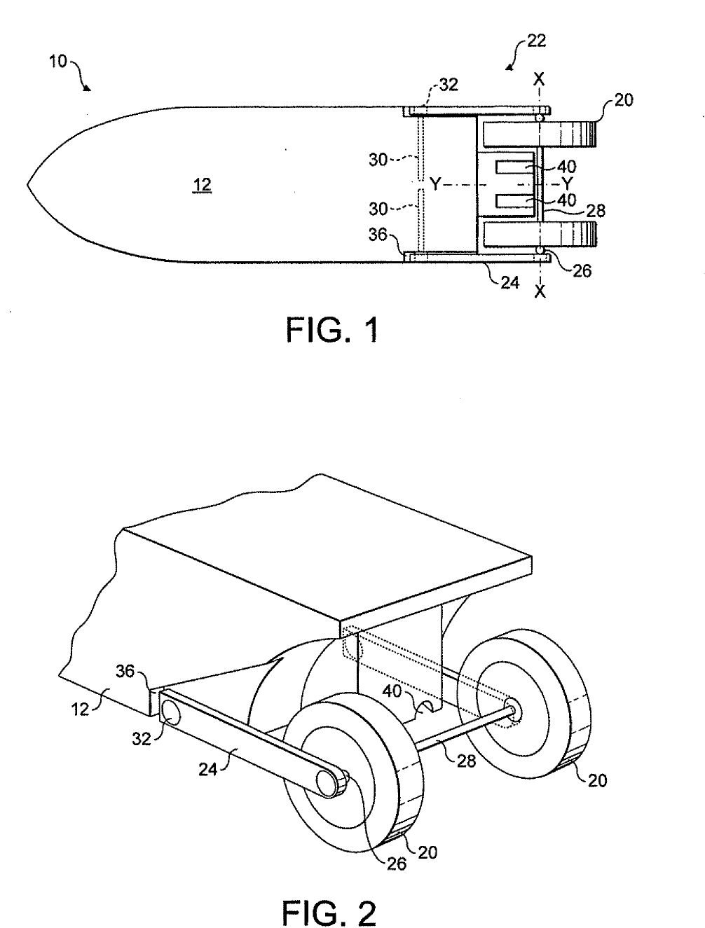

FIG. 1 is a underneath plan view of the amphibian of the present invention;

FIG. 2 is a rear perspective view of the amphibian of FIG. 1;

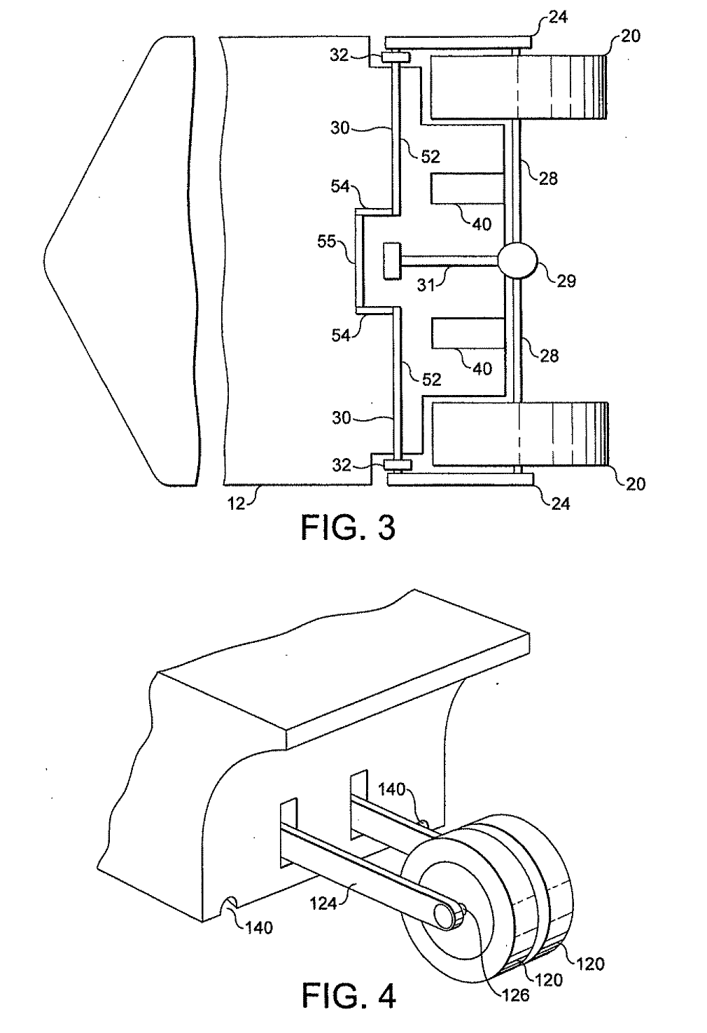

FIG. 3 is a plan view of a further embodiment of the present invention; and

FIG. 4 a rear perspective view of a further embodiment of the present invention.

Referring to the drawings, FIGS. 1 and 2 show an amphibian 10 according to the present invention. The amphibian 10 comprises a hull 12 being a buoyant vessel, and having a pair of rear wheels 20. The hull 12 is V-shaped in vertical cross-section. The amphibian 10 also has one or more front wheels (not shown).

The vehicle 10 includes a motor (not shown) or a similar power source to provide power through a transmission to the rear wheels 20. Alternatively, the motor may power the front wheels only, or may power the front wheels and rear wheels.

The rear wheels 20 are connected to the hull 12 by a suspension assembly 22. The suspension assembly 22 comprises a pair of trailing arms 24, extending rearwardly from the hull 12. The trailing arms are rotatably connected to a chassis of the vehicle (within and supporting the hull 12) at pivots 32.

The rear wheels 20 are rotatably mounted to inboard sides of the trailing arms 24, each wheel rotating about its own axis. The wheels 20 are rotatably mounted to distal ends of the arms 24, distal to the pivots 32, by mounts 26. The mounts 26 allow rotation of the wheels 20 about their common rotational axis X-X. The mounts 26 are compliantly secured on trailing arms 24 and allow relative movement between the wheels 20 and arms 24 about a substantially horizontal axis, parallel to a longitudinal axis Y-Y of the hull, in order to allow the hull 12 to roll in use on land, but to maintain good tyre contact with the ground. Although tyres of a substantially square tread cross-section are shown in the figures, tyres of a more rounded cross-section as used on motorcycles, may be used instead. The mounts 26 may each comprise a ball joint.

The two rear wheels 20 are preferably connected by an axle 28. The axle 28 assists in keeping the wheels 20 parallel. Alternatively, the pair of wheels may not be connected by an axle.

Each trailing arm 24 is spring-mounted to the vehicle, preferably by torsion bars 30 provided at or adjacent to the pivots 32. A separate torsion bar 30 is preferably provided for each arm 24. The torsion bars extend laterally towards the centre of the hull 12. Separate shock absorbers (not shown) may be provided, to damp out suspension movements.

The wheels 20 may be driven via a shaft acting through a differential (not shown) in the axle 28. The differential may be in the centre of the axle 28, or may be offset to one side.

Alternatively, the wheels 20 may each be driven by a belt or a chain. The belt or chain may be located partially or wholly inside one or each arm 24. Alternatively, a driven toothed wheel or sprocket may be provided at the centre of axle 28.

The amphibian 10 may be powered on water by one or more jet drives 40. The or each jet drive has one or more jet nozzles through which water is expelled to provide propulsion. The jet nozzles may be located between the wheels 20. The jets function as marine drives, which are separate to the wheels, which function as land drives. The marine drive or drives are fixed in position on the amphibian; as opposed to the land drives, which may be raised or lowered. The land drives may be used to provide low speed propulsion on water, but are not suitable for planing. This is firstly because they cannot transmit enough power to get the amphibian onto the plane and keep it there; and secondly, because of the hydrodynamic drag caused by the lowered wheels being located below the amphibian's waterline.

The suspension 22 is provided with a retraction mechanism, in order to retract the wheels 20 for use of the amphibian 10 on water. It is preferred to retract the wheels above the waterline, to enable the amphibian to plane. The retraction mechanism may comprise cranked torsion bars, as shown in FIG. 3. Each torsion bar 30 comprises an aligned portion 52 substantially aligned with the pivots 32, and defining a rotational axis of the torsion bar 30. Each torsion bar 30 further comprises a cranked portion 54 perpendicular to the axis of the torsion bar. The cranked portion 54 is at or near an inboard end of each torsion bar 30.

An actuator may be attached to each cranked portion 54. Contraction or extension of the actuators can be used to control retraction or deployment of the wheels 20. Alternatively, a single actuator may be connected to a cranked portion of the torsion bars 30 of both of the pair of wheels 20 (the single actuator could act on a bar 55 connecting the cranked portions 54 and shown in FIG. 3).

Alternatively, the retraction mechanism may be in the form of one or more hydraulic struts (not shown). The hydraulic struts may be connected between the arms 24 or axle 28 and the hull 12. The hydraulic struts may act both as dampers and also as hydraulic actuators to retract and deploy the wheels. Suitable hydraulic struts are known from publication US 2003/0047899.

The hull 12 has recesses 36 on either side, for receiving the arms 24. The recesses 36 allow the outboard sides of the aims 24 to be flush with outboard sides of the hull 12. The recesses are shaped to allow retraction of the wheels.

In a retracted position, the wheels 20 may be within the length of the hull 12. The hull 12 extends over and beyond the wheels 20 in their retracted position. This location of the wheels improves spray control when the amphibian is planing on water, and the wheels are in the retracted position.

With reference to FIG. 4, a pair of rear wheels 120 may be located in close proximity to each other, i.e. adjacent to each other. The closely spaced pair of wheels would be located on the central longitudinal axis of the amphibian. The closely spaced pair of wheels may effectively form a single wheel.

The pair of wheels 120 are supported on trailing arms 124 by mounts 126, substantially as described above. The trailing arms 124 are rotatably attached within the hull, and retractable using cranked torsion bars extending outwardly from the arms 124 within the hull, analogously to the cranked torsion bars described above. Preferably, each arm is connected to its own laterally outwardly extending bar, each outwardly extending bar having a cranked portion, the two cranked portions connected by a connecting strut extending laterally.

A short axle (not shown) preferably connects the wheels 120 together. A pair of jet drives 140 are located outboard of the wheels 120 (i.e. laterally offset from the wheels) for propelling the amphibian on water.

The above description relates to the use of the suspension assembly 22 on rear wheels of an amphibian. Alternatively, the same or similar suspension assembly 22 may be used for the front wheels of an amphibian. The arms 24 may extend rearwardly and support front wheels as described above. Alternatively, the arms 24 may extend forwardly, such that the supported front wheels are forward of the pivots 36. The rear wheels 20 may be supported on forwardly extending arms. The features described above would be the same or reversed as would be clear to a person skilled in the art.

The amphibian may have a total of three wheels, in the form of a pair of front wheels and a single rear wheel, or a pair of rear wheels and a single front wheel. The amphibian may have four wheels, being a front pair of wheels and a rear pair of wheels. One or both of the front and rear pair of wheels may have a suspension assembly as described. The amphibian may have more than four wheels, for example, the amphibian may have six wheels. A central pair of wheels may be located between front and rear pairs of wheels. The central pair of wheels are preferably retractable, and may or may not be driven. The additional central pair of wheels would reduce ground pressure exerted by the amphibian, and would also reduce breakover angle, for greater capability in traversing rough ground, as described in the Applicant's co-pending application GB0619244.7.

Any of the features of any embodiment may be combined with any other feature from any of the embodiments.

1. A planing amphibian for use on land and water comprising:
a hull;
a suspension assembly;
a pair of wheels mounted to the amphibian by the suspension assembly;
at least one land drive for use of the amphibian on land and at least one marine drive for use of the amphibian on water, wherein the at least one land drive is separate to the at least one marine drive; and
a wheel retraction mechanism for moving the wheels between a deployed wheel position for use of the amphibian on land and a retracted wheel position for planing of the amphibian on water; wherein the wheels are retractable to a position above a waterline of the amphibian for use of the amphibian on water;
wherein the suspension assembly comprises suspension arms each side of the pair of wheels so that the pair of wheels lie between the arms.

2. A planing amphibian according to claim 1, where the at least one marine drive is fixed in position on the amphibian.

3. A planing amphibian according to claim 1, where the suspension assembly is both sprung and damped.

4. A planing amphibian according to claim 1, where only two wheels are mounted to the amphibian by the suspension arms.

5. A planing amphibian according to claim 1, where all wheels are mounted on retractable suspensions.

6. The amphibian as claimed in claim 1 wherein the suspension arms are spaced apart by a distance less than a maximum width of the hull.

7. The amphibian as claimed in claim 1 wherein the suspension arms are trailing arms rotatably connected to the amphibian, each trailing arm connected to the outboard side of a respective wheel.

8. The amphibian as claimed in claim 7 wherein each wheel is mounted on the respective trailing arm by a compliant mount which allows relative movement between the wheel and the arm.

9. The amphibian as claimed in claim 8 wherein each mount comprises a ball joint.

10. The amphibian as claimed in claim 1 wherein the pair of wheels are a pair of rear wheels.

11. The amphibian as claimed in claim 1 wherein an axle connects the pair of wheels.

12. The amphibian as claimed in claim 11 comprising a motor connected to drive the wheels via a differential separating two parts of the axle.

13. The amphibian as claimed in claim 1 comprising a motor connected to a belt or chain drive, the belt or chain drive configured to drive the wheels.

14. The amphibian as claimed in claim 13 wherein the belt or chain drive is partially or wholly inside one or each suspension arm.

15. The amphibian as claimed in claim 1 wherein the suspension assembly comprises one or more torsion bar(s) connected to one or each of the arms.

16. The amphibian as claimed in claim 1 wherein the wheel retraction mechanism comprises one or more cranked torsion bar(s) and an actuator coupled to a cranked portion of the/each torsion bar to actuate retraction and deployment of the wheels.

17. The amphibian as claimed in claim 1 wherein the wheel retraction mechanism comprises one or more hydraulic suspension struts connected to the suspension arms.

18. The amphibian as claimed in claim 1 further comprising one or more jet drive assembly(s) for propelling the amphibian on water.

19. The amphibian as claimed in claim 18 wherein one or more outlet nozzle(s) of the jet drive assembly(s) are located between the pair of wheels.

20. The amphibian as claimed in claim 1 wherein the pair of wheels are retractable above a vehicle water line for use of the amphibian on water.

21. The amphibian as claimed in claim 1 wherein the wheels are retractable to a retracted position within the length of the hull.

22. The amphibian as claimed in claim 1 wherein the amphibian has a total of three wheels or a total of four wheels or a total of six wheels.

23. The amphibian as claimed in claim 1 wherein the pair of wheels are in close proximity to each other.

24. A wheel suspension and retraction apparatus for an amphibian having a main vehicle structure, the wheel suspension and retraction apparatus comprising:
a suspension assembly;
a pair of wheels connectable to the amphibian by the suspension assembly; and
a wheel retraction mechanism for moving the wheels between a deployed wheel position for use of the vehicle on land and a retracted wheel position for use of the vehicle on water; wherein the wheels are retractable to a position above a waterline of the amphibian for use of the amphibian on water;
wherein the suspension assembly comprises suspension arms each connected to an outboard side of one pair of wheels so that the pair of wheels lie between the suspension arms.

25. The wheel suspension and retraction apparatus as claimed in claim 24 wherein an axle connects the pair of wheels.

26. The wheel suspension and retraction apparatus as claimed in claim 24 wherein the suspension arms are a pair of trailing arms rotatably connectable to the amphibian, each trailing arm connected to the outboard side of a wheel.

27. The wheel suspension and retraction apparatus as claimed in claim 24 wherein each wheel is mounted on a suspension arm by a compliant mount which allows relative movement between the wheel and the arm.

28. The wheel suspension and retraction apparatus as claimed in claim 27 wherein each mount comprises a ball joint.

29. The wheel suspension and retraction apparatus as claimed in claim 24 wherein the suspension assembly comprises one or more torsion bar(s) connected to one or each of the arms.

30. The wheel suspension and retraction apparatus as claimed in claim 24 wherein the wheel retraction mechanism comprises one or more cranked torsion bar(s), an actuator coupled to (a) cranked portion(s) of the torsion bar(s) offset to actuate retraction and deployment of the wheels.

31. The wheel suspension and retraction apparatus as claimed in claim 24 wherein the wheel retraction mechanism comprises one or more hydraulic suspension struts connected to the suspension arms or axle.

32. The wheel suspension and retraction apparatus as claimed in claim 24 wherein the pair of wheels are in close proximity to each other.

33. (canceled)
